(19) United States
(12) Patent Application Publication
(10) Pub. No.: US 2006/0250795 A1
(43) Pub. Date: Nov. 9, 2006

(54) Means and device for providing automatically activated illumination of novelty containers

(76) Inventor: Michael Langone, W. Springfield, MA (US)

Correspondence Address: MCHALE & SLAVIN, P.A., 2855 PGA BLVD, PALM BEACH GARDENS, FL, 33410, US

(21) Appl. No.: 11/229,030

(22) Filed: Sep. 16, 2005

Related U.S. Application Data
(60) Provisional application No. 60/677,790, filed on May 3, 2005.

(51) Int. Cl. B65D 5/66; F21V 33/00

(52) U.S. Cl. 362/253; 222/113; 362/101

(57) ABSTRACT

A dispensing container has a self-contained lighting system for illumination of the container and the contents. The lighting system includes an electric/electronic circuit with LEDs and a switch. The LEDs are activated by the switch in response to movement of the dispenser.

Claiming priority of U.S. Provisional Application 60/677,790 the contents incorporated herein by reference.

### FIELD OF THE INVENTION

This invention is directed to the field of illumination of novelty vessels and in particular, perfume, cologne and similarly applied bottles.

### BACKGROUND OF THE INVENTION

Various perfumes and fragrances have been employed for thousands of years to mask offensive odors and otherwise enhance the attractiveness of an individual. Today, perfume is worn primarily as a means of attracting attention. No other sensory input evokes as much emotion as the smell of a sensual fragrance. While many of the scents and fragrances are derived from natural sources such as flowers and other plants, others are produced synthetically. Typically, perfume is a complex combination of various fragrance ingredients in a volatile base such as an alcohol. The alcohol serves to dilute concentrated scent agents and also serves as a “vehicle” to carry the scent agents to the skin of the user. Occasionally, a colorant is used to tint the perfume to add visual appeal. Since many of the essential oils and other ingredients which comprise the fragrance portion of the product are subject to oxidation and/or evaporation, it is desirable to store the perfume in sealed containers.

For this reason, perfumes are commonly, supplied in containers which are equipped with an aerosol spray top device. This permits the user to apply a precise quantity of the product in mist form which quickly coats the skin and permits rapid evaporation of the vehicle agent and preserves the life of the product by protecting it from exposure to the atmosphere. Frequently glass containers are employed to hold the undispensed product. Glass containers offer several desirable features for the storage of perfume. First, glass is inexpensive and relatively easy to mold into an infinite variety of bottle shapes. Second, glass is inert and does not react with the fragrance agents or other chemicals used in the formulation of the perfume. Third, glass containers provide an extremely good barrier between the atmosphere and any contents stored in the container. Glass (and many plastics) also offer the advantage of transparency or at least translucency thereby permitting the user to see and examine both the quality and quantity of the contents of the bottle without opening the bottle.

The fragrance business is both large and diverse being dominated primarily by giant, multinational firms. Since it is difficult to accurately describe or otherwise quantify the fragrance of a particular perfume, successful product branding is paramount to the success of any particular perfume. Huge advertising budgets produce shimmering advertisements that feature what are considered to be the most beautiful women(and men) in the world. Exotic locations, or at least blue-screen representations thereof, are employed to conjure up romance and intrigue. Frequently, the names of well-known actors are linked to the product. Sometimes in an effort to more closely link the product to the celebrity, the actor's name becomes the product name as well.

In an environment where various perfume manufactures are competing for shelf space in the retail environment, eye-catching packaging is very important. Often, the shape of a perfume bottle will be very avant garde'. Metallic coatings, gold escutcheons and other decorations are employed to lend an air of elegance to the perfume bottle and its packaging. Selective etching or coloring of the bottle may be used to add further interest. Indeed, it is not uncommon for the cost of a cosmetic package to exceed the cost of the cosmetic good itself. As with the women wearing the perfume, when it comes to the product itself, “it's all about getting noticed.” These same considerations are true of other products sold in containers, such as bottled water, soft drinks, colas, suntan lotions, shampoo, and other cosmetic lotions which would benefit from this invention.

Since it is difficult to describe the fragrance of a particular perfume with words or pictures, it is common for retail outlets to employ “sampler” bottles that may be used to sample a fragrance. While these bottles may be of a volumetric size which is either larger or smaller than the actual product for sale, the distinctive look of these samplers is typically the same as the product which is for sale.

If a cosmetic container, and in particular, a perfume bottle possessed qualities which helped potential buyers differentiate it from the myriad other products being offered for sale it would be of interest to cosmetic manufacturers. Further, if the product container provided utility to the user beyond that presently available, it would be truly useful in helping to market these cosmetic products.

If a means could be devised which permitted perfume bottles, cologne bottles or similar containers to be automatically self-illuminating, it would permit the beauty of these containers to be enjoyed in many new venues particularly in situations of low ambient light. Further, this illumination would provide an entirely new and fascinating look for these containers in that an exciting visual source of stimuli is provided in addition to the olfactory stimuli of the fragrance to be dispensed.

### DESCRIPTION OF THE PRIOR ART

The prior art includes many examples of illuminating containers for varied reasons. For example, Mattice et al, U.S. Pat. No. 5,662,406, teaches the use of an electric light bulb to illuminate a baby bottle during low ambient light conditions.

Gindi, U.S. Pat. No. 6,588,435, and British patent GB239827, to Townsend, teach the use of LEDs mounted on or in containers, carrying cosmetics or perfume, and actuated by a touch or movement of the cap to illuminate the container.

Published Patent Application, Pub. No. US 2005/0056663 to Yu and Pub. No. US 2005/0083676 to VanderSchuit, teach the use of LEDs to illuminate cosmetic containers and labels on various articles, respectively. The LEDs are activated by manual switches.

### SUMMARY OF THE INVENTION

Therefore, it is an objective of this invention to provide an economical, compact and effective system to provide illumination of containers for perfumes and similar preparations. The overall illumination effect is dependent on the exact nature of the vessel to be illuminated as well as the light propagating properties of the contents of the vessel. For example, a clear, smooth surfaced vessel will tend to function as a series of interconnected lenses which will diffract and reflect light from the source to produce more or less specular light sources which are distributed at various points within the walls of the vessel. A frosted or similarly highly irregularly surfaced vessel will tend to diffuse light and produce a soft glow which may be more or less uniform over the entire surface of the vessel. The color, if any, of the product within the vessel will also affect the visual appearance of the illuminated vessel. For example, a perfume which has been colored dark amber will typically transmit relatively less light at the blue and green wavelengths than at red, yellow and orange wavelengths. Discontinuities in the perfume such as bubbles or suspended diffractive or reflective particles will also affect the overall visual appearance of the illuminated vessel and its contents.

It is another objective of this invention to provide a light source capable of generating a plurality of colors such as may be produced by a multicolored LED which colors may be controlled by the electronic circuit. A single color light source could also be employed.

It is a further objective of this invention to provide an ultraviolet LED to cause fluorescent materials, such as the container or the product to be dispensed, to glow.

It is a further objective of this invention to provide a lighting component operatively coupled to a power source and an activation device. Any or all of these components may be located entirely external to, entirely internal to or partially external and partially internal to the vessel itself. Activation may result from a contact closure which may be triggered by normal or other mechanical action of the spray nozzle. Other activation devices may include a mechanical motion switch, a light activated motion sensor, a touch activated switch, a pressure activated switch, liquid contact switch, a thermal switch or a magnetic switch such as that employing a magnetic flux gate, reed switch or similar. The activation devices listed are for illustrative purposes and should not be interpreted as limiting.

### BRIEF DESCRIPTION OF THE DRAWINGS

FIG. 1 is an exploded perspective view of a container of this invention showing the major components of the system;

FIG. 2 is a perspective of the electronic component of this invention;

FIG. 3 is an exploded perspective of another modification of the container of this invention; and

FIG. 4 is a perspective of the end of the dip tube with lighting source therein.

### DETAILED DESCRIPTION

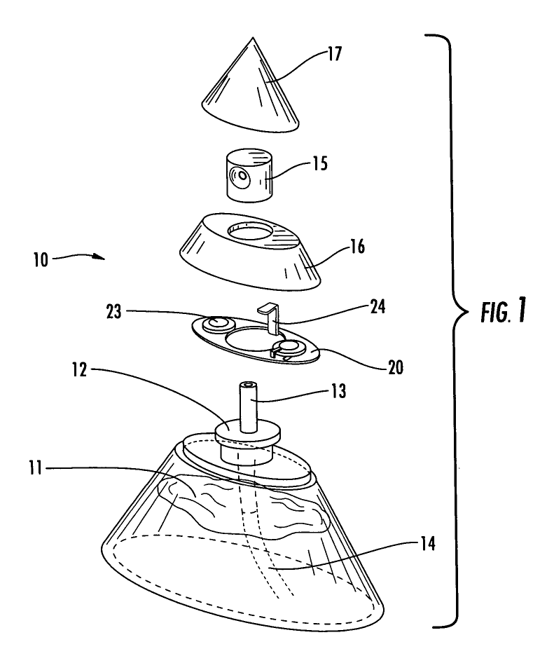

Now, referring to FIGS. 1-4, an illuminated container 10 comprises a perfume bottle 11 with bottle closure 12. Valve tube 13 dispenses liquid through spray nozzle 15 when the nozzle is urged towards perfume bottle 11. Dip tube 14 provides a conduit through which the contents of perfume bottle 11 may be drawn during the spraying action. Dip tube 14 may be transparent or translucent. Decorative cap 17 serves to protect spray nozzle 15 between uses and also provides an aesthetic improvement to the system. Escutcheon 16 may be employed to further provide aesthetic appeal and to conceal circuit board 20.

The control circuit 21 may be any conventional board with printed circuit or the like and electronic components, such as a micro-control unit, chip, or other suitable circuit to time, interrupt, modulate, or otherwise control the flow of energy from power source 23 to lighting device 22. With multiple LEDs, the control circuit can activate all simultaneously in a pattern and/or time the on/off cycles the same or differently. The circuit would normally be pre-programmed.

The power source 23 may typically be a primary electric battery such as a miniature “coin cell” or similar. The power source may also comprise a mechanically powered generator such as a piezoelectric or electromagnetic generator so that the system is “self powered” and does not require conventional batteries. Such self-powered systems may produce energy from the action of depressing the spray nozzle or shaking the vessel or through similar mechanical means.

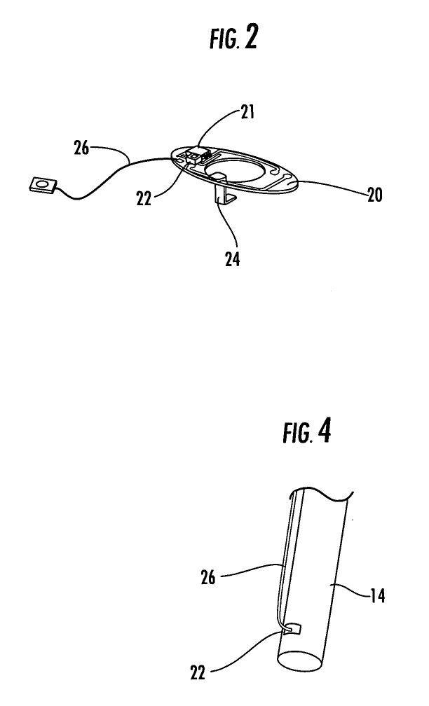

Activation device 24 may be switch or other sensing device which triggers or otherwise controls action of control circuit 21 and thereby effects light generation by lighting device 22. As shown in FIGS. 1 and 2, the switch is kinetic in that it moves between two positions to activate and de-activate the lighting source. The movement may be accomplished manually by pushing the atomizer nozzle or moving a tab on the top or base of the container. The movement can also be a result of shaking or turning the bottle upside down.

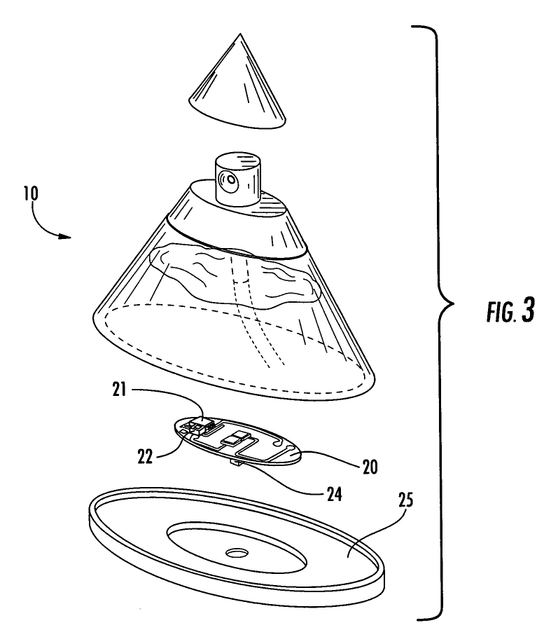

Lighting device 22 may employ any suitable light generating means but is preferably at least one light emitting diode (LED). Lighting device 22 may comprise a plurality of light sources such as LEDs of multiple colors, for example, red, blue and green. Control of the relative apparent brightness ratios of these LEDs permits generation of an infinite variety of colors. Relative brightness may be controlled either by direct current control or by pulse width control. The relative position and angular relationship between lighting device 22 and perfume bottle 11 will affect the quantity and quality of light transmitted to the user's eye from the product of the instant invention. For example, lighting device 22 may be positioned near the rear of perfume bottle 11 to produce a more diffuse look than if the lighting means were positioned close to the front of the bottle relative to the user. The bottle may be selectively frosted such as may be achieved by acid etching or grit blasting. As shown in FIGS. 1 and 3, the LEDs are located on the circuit board. However, the LED(s) can be connected to the board and power source by flexible wire 26, as shown in FIG. 2, to facilitate the positioning of a light source remote from the board and the other LED(s).

Light coupled into the walls of the bottle from lighting device 22 is then selectively permitted to escape from the bottle wall in those etched regions of the bottle. Lighting device 22 can be positioned in such a manner that a portion of the light it produces is coupled into valve tube 13 and is transmitted to dip tube 14 in a unique fiber optic like effect, as shown in FIG. 4. If some or all of the operable components of the device of the instant invention are exposed to contact with the perfume they must of course be of such a nature that they will not be degraded by this contact nor cause significant degradation of the perfume. In the case where the activation means is to be located within the bottle it may be of the pressure sensing type whereby it triggers the control circuit upon sensing a change is pressure inside the bottle such as may be generated when the dispensing nozzle is depressed and released.

As illustrated in FIG. 3, the source of illumination and the associated power source, control circuit and other associated components may be situated below the bottle and may be concealed in a base 25 that may be either removably or non-removably attached to the bottle. Any of the aforementioned sensing or triggering means may be employed in this embodiment.

A switch or other activation device 24 may protrude through the base and be spring biased so that the circuit is activated when the bottle is lifted and the weight is removed from the switch. The switch 24 may be spring biased in the opposite direction so that pressing on the top will activate the circuit. The illumination may occur only while the switch is in the spring biased position or the activation may initiate a sequence of illumination with a timed termination.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

I (We) claim:

1. A dispenser with a self-contained source of illumination comprising a container for holding the material to be dispensed, an opening in said container connected with the interior thereof, at least one LED disposed on said dispenser oriented to illuminate said container, an electric power source carried by said dispenser and operatively connected with said at least one LED by a circuit, at least one switch in said circuit to activate said LED, said switch responsive to movement of said dispenser to activate said LED.

2. A dispenser of claim 1 wherein a removable cap closes said opening, said switch activating said at least one LED when said cap is removed from said opening.

3. A dispenser of claim 1 wherein a spray nozzle is mounted in said opening whereby urging said spray nozzle towards said container activates said switch.

4. A dispenser of claim 1 wherein a plurality of LEDs is mounted on said dispenser, said circuit activating each of said plurality of LEDs in a pattern when said switch is activated.

5. A dispenser of claim 1 wherein said dispenser has a base, said container supported in said base, and said at least one LED, said circuit and said switch are located in said base.

6. A dispenser of claim 5 wherein said base and said container are separable, said at least one LED, said circuit and said switch are mounted on said container, said switch activates said at least one LED when said container is separated from said base.

7. A dispenser of claim 3 wherein a dip tube extends into said interior from said spray nozzle, said at least one LED disposed in said dip tube.

8. A dispenser of claim 7 wherein a plurality of LEDs are disposed on said dispenser.

9. A dispenser of claim 8 wherein said circuit illuminates said plurality of LEDs and said dip tube are in a pattern.

10. A dispenser of claim 4 wherein said plurality of LEDs include individual LEDs producing a different color.

11. A dispenser of claim 10 wherein said dispenser has a base, said container supported in said base, and said plurality of LEDs, said circuit and said switch are located in said base.

12. A dispenser with a self-contained source of illumination comprising a container for holding the material to be dispensed, an opening in said container connected with the interior thereof, a circuit board surrounding said opening, said circuit board having a battery connected to a plurality of LEDs by a circuit, said circuit including a switch for activating said circuit, said plurality of LEDs oriented to illuminate said interior, said plurality of LEDs having individual LEDs producing different colors, said switch activating said LEDs upon movement of said dispenser.

13. A dispenser of claim 12 wherein said circuit activates said different colors in a pattern.

14. A dispenser with a self-contained source of illumination comprising a container for holding the material to be dispensed, an opening in said container connected with the interior thereof, a base supporting said container, a circuit board in said base, said circuit board having a battery connected to a plurality of LEDs by a circuit, said circuit including a switch for activating said circuit, said plurality of LEDs oriented to illuminate said interior, said switch activating said LEDs upon separation of said container from said base.
